(19) United States
(12) Patent Application Publication
(10) Pub. No.: US 2020/0053126 A1
(43) Pub. Date: Feb. 13, 2020

(54) USER PLANE SECURITY MANAGEMENT IN A COMMUNICATION SYSTEM

(71) Applicant: Nokia Technologies Oy, Espoo (FI)

(72) Inventors: Suresh P. Nair, Whippany, NJ (US); Laurent Thiebaut, Antony (FR)

(73) Assignee: Nokia Technologies Oy, Espoo (FI)

(21) Appl. No.: 16/059,902

(22) Filed: Aug. 9, 2018

(51) Int. Cl. H04L 29/06; H04W 80/12; H04W 80/10; H04L 29/08

(52) U.S. Cl. CPC H04L 63/168; H04W 80/12; H04W 80/10; H04L 63/105; H04L 63/0485; H04L 67/141; H04L 63/0227

(57) ABSTRACT

One or more application programs are invoked at user equipment. At least one of the one or more application programs is configured with application layer security between the user equipment and a data network. A data session request is sent from the user equipment to a communication network. The communication network is configured to connect the user equipment to the data network in association with the at least one application program. The data session request comprises an indication that application layer security between the user equipment and the data network is active for the at least one application program. In one example, in response to the request, the user equipment receives a configuration message indicating that no communication network level security applies for data associated with the at least one application program.

### FIELD

The field relates generally to communication systems, and more particularly, but not exclusively, to security management within such systems.

### BACKGROUND

This section introduces aspects that may be helpful to facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point referred to as a gNB in a 5G network. The access point (e.g., gNB) is illustratively part of an access network of the communication system. For example, in a 5G network, the access network is referred to as a 5G System and is described in 5G Technical Specification (TS) 23.501, V15.2.0, entitled “Technical Specification Group Services and System Aspects; System Architecture for the 5G System,” the disclosure of which is incorporated by reference herein in its entirety. In general, the access point (e.g., gNB) provides access for the UE to a core network (CN), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, V15.1.0, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. For example, user plane (UP) security for a protocol data unit (PDU) session (also sometimes referred to as a packet data unit when the data is in packet form) is one example of security management in a 5G network. However, UP security in a PDU session presents several challenges in existing 5G approaches.

### SUMMARY

Illustrative embodiments provide improved techniques for user plane security management in communication systems.

For example, in one embodiment, a method comprises the following steps. One or more application programs are invoked at user equipment. At least one of the one or more application programs is configured with application layer security between the user equipment and a data network. A data session request is sent from the user equipment to a communication network. The communication network is configured to connect the user equipment to the data network in association with the at least one application program. The data session request comprises an indication that application layer security between the user equipment and the data network is active for the at least one application program.

In another embodiment, a method comprises the following steps. A network entity of a communication network receives a data session request sent from user equipment. The communication network is configured to connect the user equipment to a data network in association with one or more application programs invoked by the user equipment. The data session request comprises an indication that application layer security between the user equipment and the data network is active for the at least one application program. The network entity sends to the user equipment a configuration message indicating a level of communication network level security to be applied.

In one or more embodiments, the configuration message indicates that no communication network level security applies for data associated with the at least one application program.

In one or more additional embodiments, the user equipment sends a modification request to the communication network with an indication that application layer security between the user equipment and the data network is inactive for at least one of the one or more application programs. In that case, communication network level security will be applied for data associated with that application program.

Further embodiments are provided in the form of a non-transitory computer-readable storage medium having embodied therein executable program code that when executed by a processing device causes the processing device to perform the above steps. Still further illustrative embodiments comprise apparatus with a processor and a memory configured to perform the above steps.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments may be implemented.

FIG. 2 illustrates user equipment and at least one network entity for providing security management with which one or more illustrative embodiments may be implemented.

FIG. 3 illustrates a communication system architecture with network functions interacting between and within a visited network and a home network with which one or more illustrative embodiments are implemented.

FIG. 4 illustrates a methodology for user plane security for a protocol data unit session in a communication system, according to an illustrative embodiment.

FIG. 5 illustrates a methodology for user plane security for a protocol data unit session in a communication system, according to another illustrative embodiment.

### DETAILED DESCRIPTION

Embodiments will be illustrated herein in conjunction with example communication systems and associated techniques for providing security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing 3GPP system elements such as a 3GPP next generation system (5G), the disclosed embodiments can be adapted in a straightforward manner to a variety of other types of communication systems.

In accordance with illustrative embodiments implemented in a 5G communication system environment, one or more 3GPP technical specifications (TS) and technical reports (TR) provide further explanation of user equipment and network elements/functions and/or operations that interact with one or more illustrative embodiments, e.g., the above-referenced 3GPP TS 23.501 and 3GPP TS 33.501. Other 3GPP TS/TR documents provide other conventional details that one of ordinary skill in the art will realize. However, while illustrative embodiments are well-suited for implementation associated with the above-mentioned 5G-related 3GPP standards, alternative embodiments are not necessarily intended to be limited to any particular standards.

Furthermore, illustrative embodiments will be explained herein in the context of the Open Systems Interconnection model (OSI model) which is a model that conceptually characterizes communication functions of a communication system such as, for example, a 5G network. The OSI model is typically conceptualized as a hierarchical stack with a given layer serving the layer above and being served by the layer below. Typically, the OSI model comprises seven layers with the top layer of the stack being the application layer (layer 7) followed by the presentation layer (layer 6), the session layer (layer 5), the transport layer (layer 4), the network layer (layer 3), the data link layer (layer 2), and the physical layer (layer 1). One of ordinary skill in the art will appreciate the functions and interworkings of the various layers and, thus, further details of each layer are not described herein. However, it is to be appreciated that while illustrative embodiments are well-suited for implementations that utilize an OSI model, alternative embodiments are not necessarily limited to any particular communication function model.

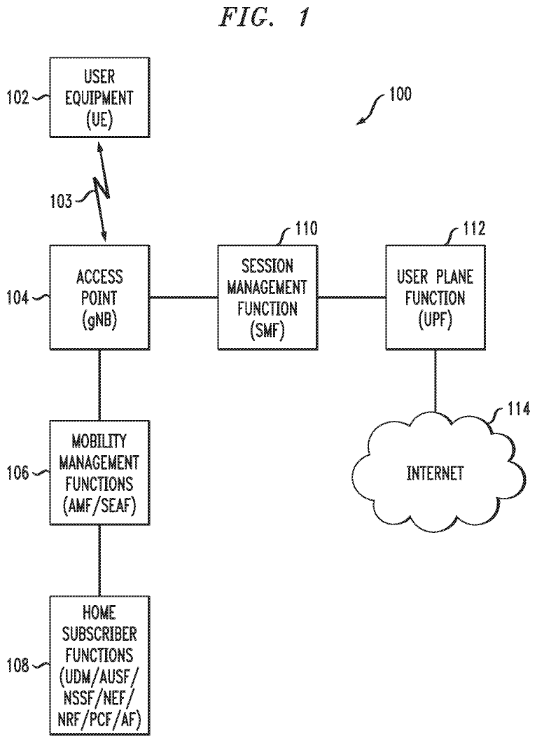

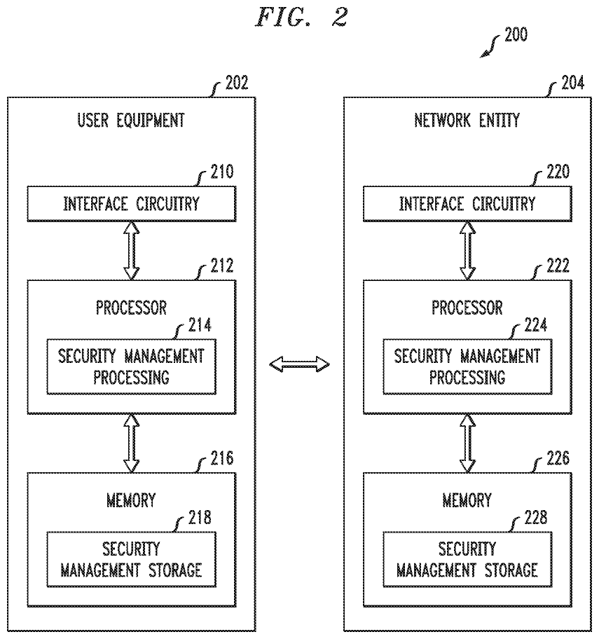

Illustrative embodiments are related to security management associated with the Service-Based Architecture (SBA) for 5G networks. Prior to describing such illustrative embodiments, a general description of main components of a 5G network will be described below in the context of FIGS. 1 and 2.

FIG. 1 shows a communication system 100 within which illustrative embodiments are implemented. It is to be understood that the elements shown in communication system 100 are intended to represent main functions provided within the system, e.g., UE access functions, mobility management functions, authentication and other security management functions, serving gateway functions, etc. As such, the blocks shown in FIG. 1 reference specific elements in 5G networks that provide these main functions. However, other network elements are used in other embodiments to implement some or all of the main functions represented. Also, it is to be understood that not all functions of a 5G network are depicted in FIG. 1. Rather, functions that facilitate an explanation of illustrative embodiments are represented. Subsequent figures depict some additional elements/functions (entities).

Accordingly, as shown, communication system 100 comprises user equipment (UE) 102 that communicates via an air interface 103 with an access point (gNB) 104. The UE 102 in some embodiments is a mobile station, and such a mobile station may comprise, by way of example, a mobile telephone, a computer, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone or other cellular device. In one or more illustrative embodiments, user equipment refers to an IoT device and/or a device that executes ultra-reliable low latency communication (URLLC) application software (also referred to herein as “application” or “applications”) where computing resources on the UE are limited or performance and timing requirements are very stringent. The term user equipment is also intended to encompass devices commonly referred to as access terminals.

In one embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores the permanent subscription identifier and its related key, which are used to identify and authenticate subscribers to access networks. The ME is the user-independent part of the UE and contains terminal equipment (TE) functions and various mobile termination (MT) functions.

Note that, in one example, the permanent subscription identifier is an International Mobile Subscriber Identity (IMSI) of a UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI).

The access point 104 is illustratively part of an access network of the communication system 100. Such an access network comprises, for example, a 5G System having a plurality of base stations and one or more associated radio network control functions. The base stations and radio network control functions in some embodiments are logically separate entities, but in some embodiments are implemented in the same physical network element, such as, for example, a base station router or femto cellular access point.

The access point 104 in this illustrative embodiment is operatively coupled to mobility management functions 106. In a 5G network, the mobility management function is implemented by an Access and Mobility Management Function (AMF). A Security Anchor Function (SEAF) in some embodiments is also implemented with the AMF connecting a UE with the mobility management function. A mobility management function, as used herein, is the element or function (i.e., entity) in the core network (CN) part of the communication system that manages or otherwise participates in, among other network operations, access and mobility (including authentication/authorization) operations with the UE (through the access point 104). The AMF is also referred to herein, more generally, as an access and mobility management entity.

The AMF 106 in this illustrative embodiment is operatively coupled to home subscriber functions 108, i.e., one or more functions that are resident in the home network of the subscriber. As shown, some of these functions include the Unified Data Management (UDM) function, as well as an Authentication Server Function (AUSF). The AUSF and UDM (separately or collectively) are also referred to herein, more generally, as an authentication entity. In addition, home subscriber functions include, but are not limited to, Network Slice Selection Function (NS SF), Network Exposure Function (NEF), Network Function Repository Function (NRF), Policy Control Function (PCF), and Application Function (AF).

It is to be understood that in an SBA communication system, such as a 5G system, the control plane uses a services model approach in which components (NFs) query the NRF to discover and communicate with each other over application programming interfaces (APIs). The NF services discovery and authorization method will be described in further detail below.

The access point 104 is also operatively coupled to a serving gateway function, i.e., Session Management Function (SMF) 110, which is operatively coupled to a User Plane Function (UPF) 112. UPF 112 is operatively coupled to a Packet Data Network, e.g., Internet 114. As is known in 5G and other communication networks, the user plane (UP) or data plane carries network user traffic while the control plane (CP) carries signaling traffic. SMF 110 supports functionalities relating to UP subscriber sessions, e.g., establishment, modification and release of PDU sessions. UPF 112 supports functionalities to facilitate UP operations, e.g., packet routing and forwarding, interconnection to the data network (e.g., 114 in FIG. 1), policy enforcement, and data buffering.

It is to be appreciated that FIG. 1 is a simplified illustration in that not all communication links and connections between NFs and other system elements are illustrated in FIG. 1. One ordinarily skilled in the art given the various 3GPP TSs/TRs will appreciate the various links and connections not expressly shown or that may otherwise be generalized in FIG. 1.

Further typical operations and functions of certain network elements are not described herein in detail when they are not the focus of illustrative embodiments but can be found in appropriate 3GPP 5G documentation. It is to be appreciated that the particular arrangement of system elements in FIG. 1 is an example only, and other types and arrangements of additional or alternative elements can be used to implement a communication system in other embodiments. For example, in other embodiments, the system 100 comprises other elements/functions not expressly shown herein. Also, although only single elements/functions are shown in the FIG. 1 embodiment, this is for simplicity and clarity of illustration only. A given alternative embodiment may include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) comprise a series of network function (NF) sets (i.e., function chains) for each corresponding service type using network function virtualization (NFV) on a common physical infrastructure. The network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via gNB 104. NFs can also access services of other NFs.

FIG. 2 is a block diagram of user equipment and at least one network entity (e.g., network element/function) for providing security management functionalities in an illustrative embodiment. System 200 is shown comprising user equipment 202 and a network entity 204. It is to be appreciated that user equipment 202 represents an example of UE 102, while network entity 204 represents any network elements/functions that are configured to provide security management and other techniques described herein, for example, but not limited to, AMF, SEAF, UDM, AUSF, NSSF, NEF, NRF, PCF, AF, SMF, and/or UPF. Network entity 204 also represents functionalities associated with an access point such as gNB 104.

User equipment 202 comprises a processor 212 coupled to a memory 216 and interface circuitry 210. The processor 212 of user equipment 202 includes a security management processing module 214 that may be implemented at least in part in the form of software executed by the processor. The processing module 214 performs security management described in conjunction with subsequent figures and otherwise herein. The memory 216 of user equipment 202 includes a security management storage module 218 that stores data generated or otherwise used during security management operations.

Network entity 204 comprises a processor 222 coupled to a memory 226 and interface circuitry 220. The processor 222 of network entity 204 includes a security management processing module 224 that may be implemented at least in part in the form of software executed by the processor 222. The processing module 224 performs security management described in conjunction with subsequent figures and otherwise herein. The memory 226 of network entity 204 includes a security management storage module 228 that stores data generated or otherwise used during security management operations.

In one or more embodiments, processors 212 and 222 of respective user equipment 202 and network entity 204 comprise, for example, microprocessors, application-specific integrated circuits (ASICs), field programmable gate arrays (FPGAs), digital signal processors (DSPs) or other types of processing devices or integrated circuits, as well as portions or combinations of such elements. Such integrated circuit devices, as well as portions or combinations thereof, are examples of “circuitry” as that term is used herein. Various embodiments use a wide variety of other arrangements of hardware and associated software or firmware.

In one or more embodiments, memories 216 and 226 of respective user equipment 202 and network entity 204 are used to store one or more software programs that are executed by the respective processors 212 and 222 to implement at least a portion of the functionality described herein. For example, security management operations and other functionality as described in conjunction with subsequent figures and otherwise herein are implemented in a straightforward manner using software code executed by processors 212 and 222.

A given one of the memories 216 or 226 can therefore be viewed as an example of what is more generally referred to herein as a computer program product or still more generally as a processor-readable storage medium that has executable program code embodied therein. Other examples of processor-readable storage media can include disks or other types of magnetic or optical media, in any combination. Illustrative embodiments also include articles of manufacture comprising such computer program products or other processor-readable storage media.

The memory 216 or 226, in some embodiments, more particularly comprise, for example, an electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 of respective user equipment 202 and network entity 204 illustratively comprise transceivers or other communication hardware or firmware that allows the associated system elements to communicate with one another in the manner described herein.

It is apparent from FIG. 2 that user equipment 202 is configured for communication with network entity 204 and vice-versa via their respective interface circuitries 210 and 220. This communication involves user equipment 202 sending data to network entity 204, and network entity 204 sending data to user equipment 202. However, in alternative embodiments, other network elements may be operatively coupled between user equipment 202 and network entity 204. Likewise, in illustrative embodiments, it is to be understood that other network elements are operatively coupled to each of user equipment 202 and network entity 204. The term “data” as used herein is intended to be construed broadly, so as to encompass any type of information that is sent between user equipment and one or more network entities (as well as between network entities) including, but not limited to, messages, information, identifiers, keys, indicators, user data, control data, etc.

Thus, in one illustrative embodiment, user equipment 202 is a 5G UE and network entity 204 is an NF, such as an SMF, UPF, or gNB. In such case, it is assumed that UE is participating in establishing a secure PDU session with the core network to which it is attached (e.g., visited public land mobile network or VPLMN which will be further described below) and exchanges data with one or more network entities as needed. Such a secure PDU session methodology will be further described below.

It is to be appreciated that the particular arrangement of components shown in FIG. 2 is an example only, and numerous alternative configurations are used in other embodiments. For example, any given user equipment and/or any given network entity can be configured to incorporate additional or alternative components and to support other communication protocols.

Other system elements (shown and not shown in FIG. 1) may each also be configured to include components such as a processor, memory and network interface. These elements need not be implemented on separate stand-alone processing platforms, but could instead, for example, represent different functional portions of a single common processing platform.

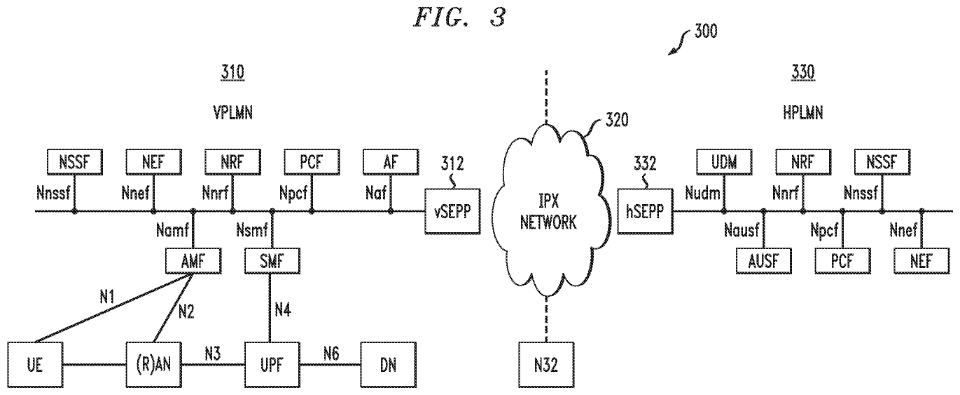

FIG. 3 depicts a 5G architecture 300 in a configuration comprising a visited public land mobile network (VPLMN) 310 operatively coupled via an intermediate Internetwork Packet Exchange (IPX) network 320 to a home public land mobile network (HPLMN) 330. Note that there can be more than one IPX network operatively coupled between VPLMN 310 and HPLMN 330. FIG. 3 also illustrates the presence of a Security Edge Protection Proxy (SEPP) at the edge of each PLMN, i.e., vSEPP 312 in VPLMN 310 and hSEPP 332 in HPLMN 330. It is to be appreciated that the various network functions shown in the VPLMN 310 and the HPLMN 330 are known and described in detail in various 5G specifications such as, but not limited to, the above-referenced TS 23.501 and TS 33.501.

As mentioned above, in 5G, SBA is introduced to model services as network functions (NFs) that communicate with each other using Restful application programming interfaces (Representational State Transfer APIs). In the scenario where the two communicating NFs are in two different PLMNs (e.g., VPLMN 310 and HPLMN 330), communication happens over a roaming inter-network interface (N32) between the two participating PLMNs. To protect NF specific content in the messages that are sent over the roaming inter-network interface, 5G introduces the SEPP as the entity residing at the perimeter of the PLMN network to protect the PLMN from outside traffic and additionally to implement transport layer security (TLS) and application layer security (ALS) for all the data and signalling exchanged between two inter-network network functions at the service layer. Note also that in addition to CP related communication links and/or connections, FIG. 3 illustrates UP related communication links and/or connections from the UE through the radio access network (RAN including a gNB) to the SMF and UPF entities, and through to the Data Network (DN).

Given the general concepts described above, illustrative embodiments that address certain security management issues will now be described. More particularly, illustrative embodiments provide improved security management techniques for 5G systems. The architecture for 5G systems is currently being standardized in 3GPP. As mentioned above, 3GPP TS 23.501 defines the 5G system architecture as service-based, e.g., Service-Based Architecture (SBA), while 3GPP TS 33.501 defines security management details.

More particularly, it is realized herein that in the existing 5G specifications (e.g., 3GPP TS 23.501 § 5.10.3 and 3GPP TS 33.501, clause 6.6), the UP security policy for a PDU session is determined by network policies that do not take account of applications that are deployed on the UE having established this PDU session. That is, as stated in the existing 5G specifications, the SMF determines, at PDU session establishment, UP security enforcement information for the UP of a PDU session based on: (i) a subscribed UP security policy which is part of session management (SM) subscription information received from the UDM; and (ii) a UP security policy locally configured per (DNN, S-NSSAI) in the SMF that is used when the UDM does not provide UP security policy information (wherein DNN refers to Data Network Name and S-NSSAI refers to Single Network Slice Selection Assistance Information); and the maximum supported data rate per UE for integrity protection for the DRBs, provided by the UE as part of the SGSM capability IE (information element) during PDU session establishment (wherein DRBs are data radio bearers which are channels offered by the data link layer to higher layers for the transfer of user data).

Once the UP security policy has been determined, it is sent from the SMF to the NG RAN (e.g. gNB) when requiring PDU session resources. The UP security policy indicates whether UP confidentiality and/or UP integrity protection is activated or not for all DRBs belonging to that PDU session. The UP security policy is used to activate UP confidentiality and/or UP integrity for all DRBs belonging to the PDU session.

However, it is realized herein that the existing 5G specifications lack certain security features. For example, in existing 5G specifications, there is no indication from the application layer in the UE to the connection setup layer in the network to indicate that there is end-to-end (e2e) application layer security (ALS) in place, and thus that the application does not depend on the radio layer security between the UE and the gNB or network elements such as UPF or AMF.

More particularly, as per the existing definition in TS 33.501 clause 6.6, the SMF shall provide UP security policy for a PDU session to the gNB during the PDU session establishment procedure as specified in 5G Technical Specification (TS) 23.502, V15.2.0, entitled “Technical Specification Group Services and System Aspects; Procedures for the 5G System, Stage 2,” the disclosure of which is incorporated by reference herein in its entirety. However, as mentioned above in accordance with realizations herein, there is no way for the UE to indicate to the network that there is already application layer security in place between the UE and the end-to-end server and that PLMN level UP security should not apply. It is to be understood that the term “PLMN level UP security” refers to the security enforced between the UE and a PLMN entity belonging to the NG RAN or to the 5G core network. There are many applications such as, but not limited to, IoT or URLLC applications where computing resources on the UE are limited or performance and timing requirements are very stringent. In such situations, it is realized herein that radio layer security between the UE and the network entities (i.e., gNB or UPF) can be avoided by making use of the application layer security. Any savings on the processing cycles by avoiding access stratum (AS) layer encryption on the UE are significant.

Currently, avoiding PLMN level encryption or integrity protection on a per DRB or application basis is not possible, once the AS security mode command (SMC) procedure is completed. Except in countries where UP encryption is not allowed by law, UP data is mandatorily encrypted using the negotiated algorithms between the UE and the gNB.

Accordingly, it is realized that policies on UP security for a PDU session are determined by network policies that do not take into account that applications that are deployed on the UE have established this PDU Session. In the network, as mentioned above, the UP security policy is defined per APN/DNN (APN refers to access point name) and slice (S-NSSAI). Thus, in existing approaches, all user traffic sent on the same (DNN, S-NSSAI) gets the same UP security policy.

One possibility to address this situation would be to define different DNNs for the access to the same Data Network, i.e., one DNN where UP security applies and one where it does not. However, this may be cumbersome for the PLMN operation as it would require network operators to configure twice the number of DNNs in their network. DNN configuration is typically burdensome to a network operator since it requires the network operator to configure a DNN on the UE, on the NRF, on the SMF and on the subscription data.

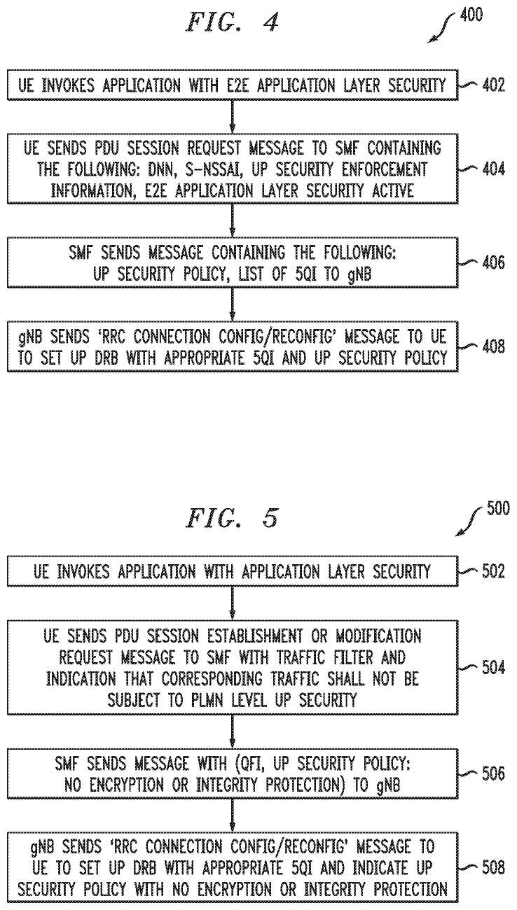

Illustrative embodiments overcome the above and other drawbacks by introducing the negotiation of PLMN level UP security requirements (i.e., parameters) in session management (SM) signalling from the UE to the network. FIGS. 4 and 5 will be described below to illustrate exemplary embodiments of this improved security management technique. While reference will be made below to components in FIG. 1, it is to be understood that the techniques are implementable in alternative communication system configurations.

In accordance with one illustrative embodiment, as will be described in the context of FIG. 4, UE 102 subscribes to a single (DNN, S-NNSAI) but requests in association with this single (DNN, S-NNSAI) subscription:

(i) A PDU session with PLMN level UP security; and/or

(ii) A PDU session without PLMN level UP security.

UE 102 indicates its desire to establish a PDU session with or without PLMN level UP security by providing an explicit indication in an NAS signaling message at the establishment of the PDU session. Once this indication (PLMN level ‘UP security required/UP security shall not apply’ to the whole PDU session) has been received by SMF 110, SMF 110 cross checks whether it is compatible with network policies and indicates the level of PLMN level UP security provided to the PDU session in its answer to UE 102. The UP security of the PDU session is provided to the NG RAN node, e.g., gNB 104, per existing 5G specifications.

This embodiment is transparent for an NG RAN node that supports the 3GPP R15 UP security policy per 3GPP R15 TS 23.501 § 5.10.3 and TS 33.501 clause 6.6.

In one or more embodiments, the following mechanisms apply in the UE to decide whether a PDU session without UP security needs to be established or to be used:
(i) An application can be associated together with the corresponding (DNN, S-NSSAI) with a PLMN level UP security requirement in the UE Route Selection Policy or URSP (network operator policies configured in UE 102); if, when an application requests data connectivity there is no current PDU session already established by UE 102 for the 3-tuple (DNN, S-NSSAI, PLMN level UP security requirement) associated with the application, UE 102 requests a PDU session with such parameters.
(ii) An application can provide to the 3GPP modem, by implementation means, its (DNN, S-NSSAI, PLMN level UP security requirement).

This approach supports PLMN level UP security from UE 102 to SMF 110 on a per DNN basis and aligns with existing signalling.

In one or more embodiments, the PLMN level UP security includes indicators that indicate that end-to-end (i.e., between the application layer in the UE to the application server in the data network) encryption is active, end-to-end integrity protection is active, or both end-to-end encryption and end-to-end integrity protection are active.

Referring now to FIG. 4, methodology 400 illustrates the above approach for a PDU session set up request according to an illustrative embodiment.

In step 402, UE 102 invokes an application with e2e application layer security.

In step 404, UE 102 sends a PDU session request message to SMF 110 containing the following: DNN, S-NSSAI, UP Security Enforcement Information, E2E Application Layer Security Active. Advantageously, step 404 introduces the negotiation of PLMN level UP security requirements (i.e., parameters) in SM signalling from UE 102 to the network (SMF 110).

In step 406, SMF 110 sends a response message containing the following: UP Security Policy, list of 5QIs to gNB 104. 5QI refers to 5G QoS (Quality-of-Service) Identifier.

In step 408, gNB 104 sends ‘RRC Connection Configuration/Reconfiguration’ message to UE 102 to set up a data radio bearer (DRB) with appropriate 5QI and UP security policy. RRC refers to Radio Resource Control. In some embodiments, gNB 104 instructs UE 102 to map the application to a new DRB or to an existing DRB, if an existing DRB matching the 5QI and the UP security policy is already established and available.

In an alternative embodiment, the PDU session is requested by UE 102 with fine granularity of PDU session on a per application flow basis. This embodiment is illustrated in FIG. 5. It is to be understood that while the FIG. 4 embodiment uses different PDU sessions when applications with the same DNN have different security requirements, the FIG. 5 embodiment uses the same PDU session with some application flows protected by PLMN security, and other application flows using application layer security without using PLMN security. In SM signaling sent to the network (PDU Session Establishment or PDU Session Modification Request), UE 102 provides a traffic filter (e.g., application identifier and/or a 5-tuple) and indicates that corresponding traffic shall not be subject to UP security. As mentioned, in some embodiments, one PDU session has multiple applications, wherein some of the applications have application layer security and some do not.

Referring now to FIG. 5, methodology 500 illustrates the above approach for a PDU session set up request according to another illustrative embodiment.

In step 502, UE 102 invokes an application with e2e application layer security.

In step 504, UE 102 sends a PDU session establishment or PDU session modification request message to SMF 110 with the above-mentioned traffic filter and an indication that the corresponding user traffic shall not be subject to PLMN level UP security. Again, advantageously, step 504 introduces the negotiation of PLMN level UP security requirements (i.e., parameters) in SM signalling from UE 102 to the network (SMF 110).

In step 506, SMF 110 sends a response message containing the following: QFI, UP Security Policy: no encryption or integrity protection to gNB 104. QFI refers to QoS Flow Identifier.

In step 508, gNB 104 sends ‘RRC Connection Configuration/Reconfiguration’ message to UE 102 to set up a DRB with appropriate 5QI for the application and an indication that UP security policy shall not use encryption or integrity protection. The RRC Connection Configuration/Reconfiguration message instructs UE 102 to map the application flow to the signaled data radio bearer (DRB). In some embodiments, the DRB indicated by the gNB may be a new DRB or it could be an existing DRB matching the 5QI requirements and the security policy.

The particular processing operations and other system functionality described in conjunction with the flow diagrams of FIGS. 4 and 5 are presented by way of illustrative example only, and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should therefore again be emphasized that the various embodiments described herein are presented by way of illustrative example only and should not be construed as limiting the scope of the claims. For example, alternative embodiments can utilize different communication system configurations, user equipment configurations, base station configurations, provisioning and usage processes, messaging protocols and message formats than those described above in the context of the illustrative embodiments. These and numerous other alternative embodiments within the scope of the appended claims will be readily apparent to those skilled in the art.

What is claimed is:

1. A method comprising:
invoking one or more application programs at user equipment, wherein at least one of the one or more application programs is configured with application layer security between the user equipment and a data network; and
sending a data session request from the user equipment to a communication network, wherein the communication network is configured to connect the user equipment to the data network in association with the at least one application program, and wherein the data session request comprises an indication that application layer security between the user equipment and the data network is active for the at least one application program;
wherein the user equipment comprises at least one processing device configured to execute the invoking and sending steps.

2. The method of claim 1, further comprising the user equipment receiving a configuration message from the communication network indicating a level of communication network level security to be applied.

3. The method of claim 2, wherein the level of communication network level security in the configuration message indicates that no communication network level security applies for data associated with the at least one application program.

4. The method of claim 3, wherein application layer security comprises one or more of encryption and integrity protection.

5. The method of claim 1, further comprising the user equipment sending a modification request to the communication network with an indication that application layer security between the user equipment and the data network is inactive for at least one of the one or more application programs.

6. The method of claim 5, wherein the modification request further comprises a filter to indicate which of the one or more application programs has application layer security active and which of the one or more application programs does not have application layer security active.

7. The method of claim 6, further comprising the user equipment receiving a reconfiguration message from the communication network indicating a level of communication network level security to be applied.

8. The method of claim 7, wherein the level of communication network level security in the reconfiguration message indicates that communication network level security applies for data associated with the application program for which application layer security is inactive.

9. The method of claim 1, further comprising the user equipment establishing another data session for another one of the invoked application programs configured with application layer security between the user equipment and another data network by sending another data session request to the communication network, wherein the other data session request comprises an indication that application layer security between the user equipment and the other data network is one of active and inactive.

10. The method of claim 1, wherein the data session comprises a protocol data unit (PDU) session.

11. The method of claim 1, wherein the communication network comprises a 5G network.

12. An article of manufacture comprising a non-transitory computer-readable storage medium having embodied therein executable program code that when executed by a processing device of user equipment causes the user equipment to perform the steps of:
invoking one or more application programs, wherein at least one of the one or more application programs is configured with application layer security between the user equipment and a data network; and
sending a data session request to a communication network, wherein the communication network is configured to connect the user equipment to the data network in association with the at least one application program, and wherein the data session request comprises an indication that application layer security between the user equipment and the data network is active for the at least one application program.

13. Apparatus comprising:
at least one processor coupled to a memory associated with user equipment configured to:
invoke one or more application programs, wherein at least one of the one or more application programs is configured with application layer security between the user equipment and a data network; and
sending a data session request from the user equipment to a communication network, wherein the communication network is configured to connect the user equipment to the data network in association with the at least one application program, and wherein the data session request comprises an indication that application layer security between the user equipment and the data network is active for the at least one application program.

14. The apparatus of claim 13, wherein the user equipment is further configured to receive a configuration message from the communication network indicating a level of communication network level security to be applied.

15. The apparatus of claim 14, wherein the level of communication network level security in the data session configuration message indicates that no communication network level security applies for data associated with the at least one application program.

16. The apparatus of claim 15, wherein application layer security comprises one or more of encryption and integrity protection.

17. The apparatus of claim 13, wherein the user equipment is further configured to send a modification request to the communication network with an indication that application layer security between the user equipment and the data network is inactive for at least one of the one or more application programs.

18. The apparatus of claim 17, wherein the modification request further comprises a filter to indicate which of the one or more application programs has application layer security active and which of the one or more application programs does not have application layer security active.

19. The apparatus of claim 18, wherein the user equipment is further configured to receive a reconfiguration message from the communication network indicating a level of communication network level security to be applied.

20. The apparatus of claim 19, wherein the level of communication network level security in the reconfiguration message indicates that communication network level security applies for data associated with the application program for which application layer security is inactive.

21. The apparatus of claim 13, wherein the user equipment is further configured to establish another data session for another one of the invoked application programs configured with application layer security between the user equipment and another data network by sending another data session request to the communication network, wherein the other data session request comprises an indication that application layer security between the user equipment and the other data network is one of active and inactive.

22. The apparatus of claim 13, wherein the data session comprises a protocol data unit (PDU) session.

23. The apparatus of claim 13, wherein the communication network comprises a 5G network.

24. A method comprising:
receiving at a network entity of a communication network a data session request sent from user equipment, wherein the communication network is configured to connect the user equipment to a data network in association with one or more application programs invoked by the user equipment, and wherein the data session request comprises an indication that application layer security between the user equipment and the data network is active for the at least one application program; and
sending from the network entity to the user equipment a configuration message indicating a level of communication network level security to be applied;
wherein the network entity comprises at least one processing device configured to execute the invoking and sending steps.

25. The method of claim 24, wherein the level of communication network level security in the configuration message indicates that no communication network level security applies to data associated with the at least one application program.

26. The method of claim 24, wherein the network entity comprises a session management function.

27. The method of claim 24, further comprising the network entity receiving a modification request from the user equipment with an indication that application layer security between the user equipment and the data network is inactive for at least one of the one or more application programs.

28. The method of claim 27, wherein the modification request further comprises a filter to indicate which of the one or more application programs has application layer security active and which of the one or more application programs does not have application layer security active.

29. An article of manufacture comprising a non-transitory computer-readable storage medium having embodied therein executable program code that when executed by a processing device of a network entity of a communication network causes the network entity to perform the steps of:
receiving a data session request sent from user equipment, wherein the communication network is configured to connect the user equipment to a data network in association with one or more application programs invoked by the user equipment, and wherein the data session request comprises an indication that application layer security between the user equipment and the data network is active for the at least one application program; and
sending a configuration message indicating a level of communication network level security to be applied.

30. Apparatus comprising:
at least one processor coupled to a memory associated with a network entity of a communication network configured to:
receive a data session request sent from user equipment, wherein the communication network is configured to connect the user equipment to a data network in association with one or more application programs invoked by the user equipment, and wherein the data session request comprises an indication that application layer security between the user equipment and the data network is active for the at least one application program; and
send a configuration message indicating a level of communication network level security to be applied.
